(19) United States
(12) Patent Application Publication
(10) Pub. No.: US 2014/0360025 A1
(43) Pub. Date: Dec. 11, 2014

(54) SCISSORS

(71) Applicant: Milwaukee Electric Tool Corporation, Brookfield, WI (US)

(72) Inventors: Steven W. Hyma, Milwaukee, WI (US); Michael S. Steele, Waukesha, WI (US); Matthew W. Naiva, Wauwatosa, WI (US); Justin Ferrante, Wauwatosa, WI (US)

(21) Appl. No.: 14/298,362

(22) Filed: Jun. 6, 2014

Related U.S. Application Data
(60) Provisional application No. 61/831,972, filed on Jun. 6, 2013.

(51) Int. Cl. B26B 13/20

(52) U.S. Cl. CPC B26B 13/20
USPC 30/254

(57) ABSTRACT

A scissors including a first member formed from a first material, the first member including a first cutting edge and a first loop. The scissors further including a second member, the second member pivotally coupled to the first member at a pivot joint, the second member including a second cutting edge adjacent the first cutting edge and a second loop adjacent the first loop. A first grip is formed from a second material that surrounds a portion of the first loop, the first grip including an aperture that exposes a portion of the first loop formed from the first material. A second grip surrounds at least a portion of the second loop.

### CROSS-REFERENCE TO RELATED APPLICATIONS

This application claims priority to U.S. Provisional Patent Application No. 61/831,972, filed Jun. 6, 2013, the entire contents of which are hereby incorporated by reference herein.

### BACKGROUND

The present invention relates to scissors, which are also referred to as shears. Scissors typically include blades that are pivotally coupled. The blades are pivoted by handles, typically loops, and are used to cut work-pieces, such as paper, cardboard, foil, cloth, rope, etc. The loops are often covered with a plastic grip material and the plastic grip material is prone to breakage if the scissors are dropped.

### SUMMARY

In one embodiment, the invention provides a scissors including a first member formed from a first material, the first member including a first cutting edge and a first loop. The scissors further including a second member, the second member pivotally coupled to the first member at a pivot joint, the second member including a second cutting edge adjacent the first cutting edge and a second loop adjacent the first loop. A first grip is formed from a second material that surrounds a portion of the first loop, the first grip including an aperture that exposes a portion of the first loop formed from the first material. A second grip surrounds at least a portion of the second loop.

In another embodiment the invention provides a scissors including a first member formed from a first material, the first member including a first cutting edge, a first loop, a first tip adjacent the first cutting edge, and a first back end opposite the first tip and adjacent the first loop. The scissors further includes a second member, the second member pivotally coupled to the first member at a pivot joint, the second member including a second cutting edge, a second loop, a second tip adjacent the second cutting edge, and a second back end opposite the second tip and adjacent the second loop. A first grip is formed from a second material that surrounds a portion of the first loop, the first grip including an aperture that exposes a portion of the back end of the first loop formed from the first material. A second grip surrounds at least a portion of the second loop.

Other aspects of the invention will become apparent by consideration of the detailed description and accompanying drawings.

### BRIEF DESCRIPTION OF THE DRAWINGS

FIG. 1 is a perspective view of a scissors according to an embodiment of the invention.

FIG. 2 is a first side view of the scissors of FIG. 1.

FIG. 3 is a second side view of the scissors of FIG. 1 with grips of the scissors removed.

FIG. 4 is a perspective view of a scissors accordingly to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

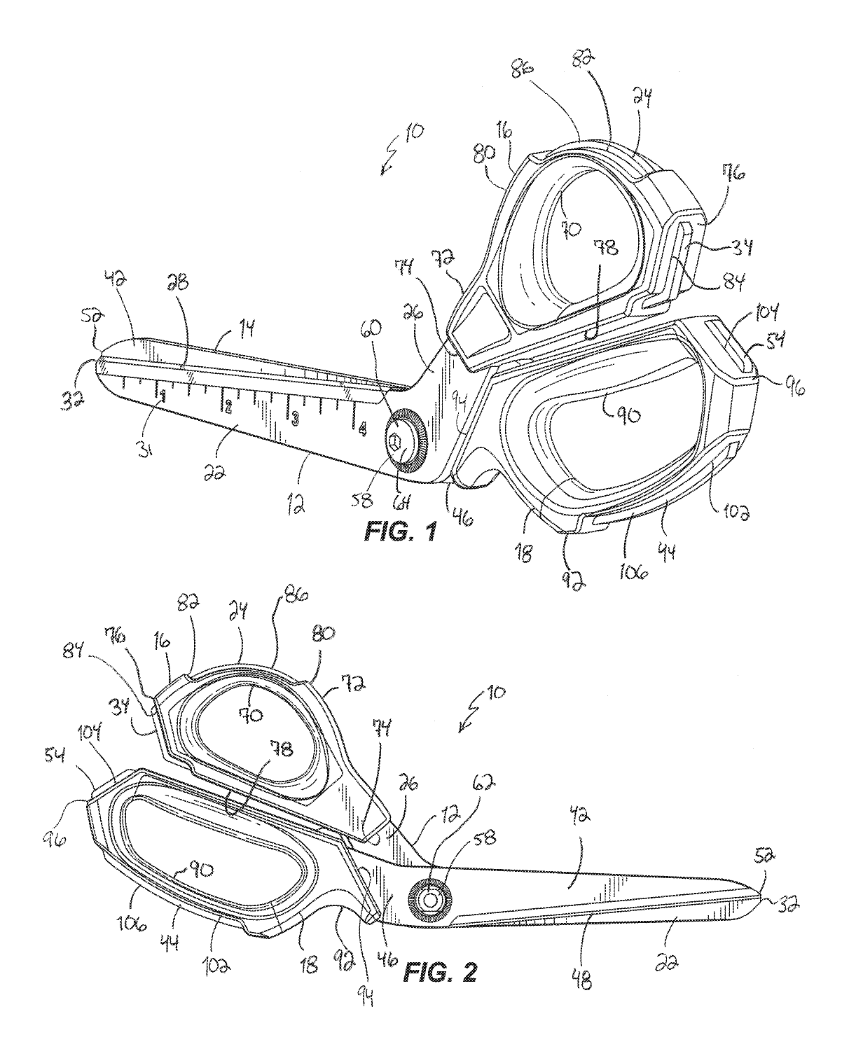

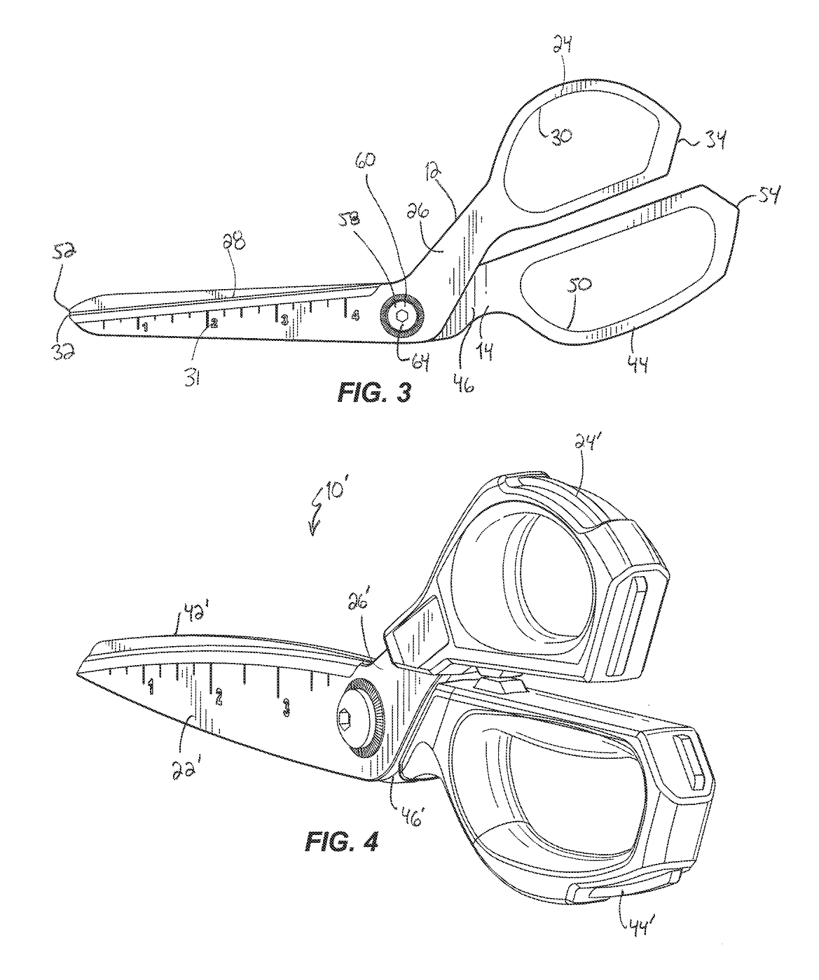

FIG. 1 illustrates a scissors 10. The scissors 10 includes a first member 12, a second member 14, a first grip 16, and a second grip 18. Referring to FIG. 3, the first member 12 includes a blade 22 and a loop 24. An arm 26 extends between the blade 22 and the loop 24. The blade 22 includes a cutting edge 28. In the illustrated embodiment, a ruler 31 is located on the blade 22. The ruler 31 can be used to measure the work-piece that is being cut by the scissors 10. The loop 24 includes an aperture 30. In the illustrated embodiment, material of the first member 12 continually surrounds the aperture 30 such that the loop 24 is continuous. In other embodiments, the loop may not be continuous, that is, the loop may not extend all 360 degrees around the aperture 30. The first member 12 further includes a tip 32 and a back end 34. The tip 32 is adjacent the cutting edge 28 at an end of the first member 12 and the back end 34 is adjacent the loop 24 at an end of the first member 12 opposite the tip 32. The first member 12 is integrally formed as a single component from metal in the illustrated embodiment.

The second member 14 includes a blade 42 and a loop 44. An arm 46 extends between the blade 42 and the loop 44. The blade 42 includes a cutting edge 48 adjacent the cutting edge 28 of the first member 12. The loop 44 includes an aperture 50. In the illustrated embodiment, material of the second member 14 continually surrounds the aperture 50 such that the loop 44 is continuous. In other embodiments, the loop may not be continuous, that is, the loop may not extend all 360 degrees around the aperture 50. The second member 14 further includes a tip 52 and a back end 54. The tip 52 is adjacent the cutting edge 48 at an end of the second member 14 and the back end 54 is adjacent the loop 44 at an end of the second member 14 opposite the tip 52. The second member 14 is integrally formed as a single component from metal in the illustrated embodiment.

Referring to FIGS. 1 and 2, the first member 12 and the second member 14 are pivotally coupled at a pivot joint 58. In the illustrated embodiment, the pivot joint 58 is formed by a bolt 60 and a nut 62. The bolt 60 includes a head 64 that is rounded. The rounded head 64 inhibits the bolt 60 from catching or snagging on a user's tool belt or the like and facilitates easy insertion and removal into a user's tool belt.

The first grip 16 surrounds a substantial portion of the first loop 24. The grip 16 is formed from a material different than the first and second member 12, 14. In one embodiment, the grip 16 is formed from a thermoplastic, which is more brittle than the metal material of the first and second members 12, 14. In another embodiment, the grip 16 is formed from rubber. Generally, the metal material of the first and second members 12, 14 is harder than the material of the grip 16. The material of the grip 16 provides the user with a comfortable place to grasp the loop 24.

The first grip 16 includes an interior loop portion 70 and an exterior loop portion 72. The interior loop portion 70 is generally located inside the loop 24. The exterior loop portion 72 generally surrounds the outside of the loop 24 and includes a front end portion 74, a back end portion 76 opposite the front end portion 74, an inside portion 78, and an outside portion 80. The arm 26 of the first member 12 extends through the front end portion 74 to the pivot joint 58. The first grip 16 includes an aperture 82 that extends through the outside portion 80 to expose a portion 86 of the metal material of the loop 24. The grip 16 includes an aperture 84 that extends through the back end portion 76 to expose the back end 34 of the first member 12. The purpose of the apertures 82, 84 will be discussed in more detail below.

The second grip 18 surrounds a substantial portion of the second loop 44. The grip 18 is formed from a material different than the first and second members 12, 14. In one embodiment, the grip 18 is formed from a thermoplastic, which is more brittle than the metal material of the first and second members 12, 14. In another embodiment, the grip 18 is formed from rubber. Generally, the metal material of the first and second members 12, 14 is harder than the material of the grip 18. The material of the grip 18 provides the user with a comfortable place to grasp the loop 44.

The second grip 18 includes an interior loop portion 90 and an exterior loop portion 92. The interior loop portion 90 is generally located inside the loop 44. The exterior loop portion 92 generally surrounds the outside of the loop 44 and includes a front end portion 94, a back end portion 96 opposite the front end portion 94, an inside portion 98, and an outside portion 100. The arm 46 of the second member 14 extends through the front end portion 94 to the pivot joint 58. The grip 18 includes an aperture 102 that extends through the outside portion 100 to expose a portion 106 of the metal material of the loop 44. The grip 18 includes an aperture 104 that extends through the back end portion 96 to expose the back end 54 of the second member 14.

The exposed back end portions 34, 54 and the exposed portions 86, 106 reduce the likelihood that the grips 16, 18 will become damaged if the scissors are dropped. As discussed above, in one embodiment, the grips 16, 18 are formed from a material that is more brittle than and/or not as hard as the metal material of the members 12, 14. Therefore, if the scissors are dropped and, particularly if the grips directly impact the surface onto which the scissors fall, the grips 16, 18 are more susceptible to cracking, breaking, and other types of damage than the metal members 12, 14. The exposed portions 34, 54, 86, 106 are located on the grips 16, 18 where the scissors is most likely to impact when dropped. Therefore, the impact of the fall is directed to the members 12, 14 and not to the grips 16, 18. The metal material of the members 12, 14 is generally more impact resistant than the grips 16, 18, in some embodiments, and the exposed portions 34, 54, 86, 106 reduce the likelihood of damage to the grips 16, 18 if the scissors is dropped.

FIG. 4 illustrates a scissors 10′ according to another embodiment. The scissors 10′ is similar to the scissors 10 of FIGS. 1-3 and only differences between the scissors will be discussed and like components have been given like reference number plus a prime (′) symbol. The scissors 10′ includes arms 26′, 46′ that are angled less relative to the blades 22′, 42′ than the arms 26, 46 of the scissors 10 of FIG. 1-4. Accordingly, the orientation of the loops 24, 44 relative to the blades 22, 42 of the scissors 10 is referred to as an offset orientation and the orientation of the loops 24′, 44′ relative to the blades 22, 42 of the scissors 10′ is referred to as a straight configuration.

The invention provides, among other things, a scissors with grips that are less susceptible to damage when dropped. Various features and advantages of the invention are set forth in the following claims.

What is claimed is:

1. A scissors comprising:
a first member formed from a first material, the first member including a first cutting edge and a first loop;
a second member, the second member pivotally coupled to the first member at a pivot joint, the second member including a second cutting edge adjacent the first cutting edge and a second loop adjacent the first loop; and
a first grip formed from a second material that surrounds a portion of the first loop, the first grip including an aperture that exposes a portion of the first loop formed from the first material; and
a second grip that surrounds at least a portion of the second loop.

2. The scissors of claim 1, wherein the first material has a hardness greater than the second material.

3. The scissors of claim 1, wherein the first material includes metal and the second material includes a thermoplastic.

4. The scissors of claim 1, wherein the first material includes metal and the second material includes rubber.

5. The scissors of claim 1, wherein the second member is formed from the first material, wherein the second grip is formed from the second material, and wherein the second grip includes an aperture that exposes a portion of the second loop formed form the first material.

6. The scissors of claim 1, wherein the first and second grips each include a front end portion, a back end portion opposite the front end portion, an inside portion, and an outside portion opposite the inside portion, wherein the inside portions of the first and second grips face each other and the outside portions of the first and second grips face in generally opposite directions, and wherein the aperture of the first grip that exposes the portion of the first loop extends through the outside portion of the first grip.

7. The scissors of claim 6, wherein the first member extends through the front end portion of the first grip, and wherein the second member extends through the front end portion of the second grip.

8. The scissors of claim 6, wherein the aperture of the first grip is a first aperture and the portion of the first loop that is exposed is a first portion, the first grip further including a second aperture that exposes a second portion of the first loop.

9. The scissors of claim 8, wherein the second aperture extends through the back end portion of the first grip.

10. The scissors of claim 9, wherein a portion of the first grip surrounds the first loop between the first and second apertures.

11. The scissors of claim 1, wherein the first and second grips each include a front end portion, a back end portion opposite the front end portion, an inside portion, and an outside portion opposite the inside portion, wherein the inside portions of the first and second grips face each other and the outside portions of the first and second grips face in generally opposite directions, and wherein the aperture of the first grip that exposes the portion of the first loop extends through the back end portion of the first grip.

12. The scissors of claim 11, wherein the first member extends through the front end portion of the first grip, and wherein the second member extends through the front end portion of the second grip.

13. A scissors comprising:
a first member formed from a first material, the first member including a first cutting edge, a first loop, a first tip adjacent the first cutting edge, and a first back end opposite the first tip and adjacent the first loop;
a second member, the second member pivotally coupled to the first member at a pivot joint, the second member including a second cutting edge, a second loop, a second tip adjacent the second cutting edge, and a second back end opposite the second tip and adjacent the second loop;
a first grip formed from a second material that surrounds a portion of the first loop, the first grip including an aperture that exposes a portion of the back end of the first loop formed from the first material; and
a second grip that surrounds at least a portion of the second loop.

14. The scissors of claim 13, wherein the first material has a hardness greater than the second material.

15. The scissors of claim 13, wherein the first material includes metal and the second material includes a thermoplastic.

16. The scissors of claim 13, wherein the first material includes metal and the second material includes rubber.

17. The scissors of claim 13, wherein the second member is formed from the first material, wherein the second grip is formed from the second material, and wherein the second grip includes an aperture that exposes a portion of the back end of the second loop formed form the first material.

18. The scissors of claim 13, wherein the first and second grips each include a front end portion, a back end portion opposite the front end portion, an inside portion, and an outside portion opposite the inside portion, wherein the inside portions of the first and second grips face each other and the outside portions of the first and second grips face in generally opposite directions, wherein the aperture of the first grip is a first aperture, the first grip further including a second aperture that exposes a second portion of the first loop.

19. The scissors of claim 18, wherein the first member extends through the front end portion of the first grip, and wherein the second member extends through the front end portion of the second grip.

20. The scissors of claim 19, wherein the second aperture extends through the outside portion of the first grip.
